(19) United States
(12) Patent Application Publication
(10) Pub. No.: US 2005/0046220 A1
(43) Pub. Date: Mar. 3, 2005

(54) Cantilever supported vehicle seat and system

(75) Inventors: Cynthia Hernandez, Canton, MI (US); Alan Collins, West Sussex (GB); Marne Hollis, Duesseldorf (DE); Charlotte Schiffer, Burscheid (DE); Roger Whitley, Brighton, MI (US)

Correspondence Address: JOHN VANOPHEM;FOLEY & LARDNER, 500 WOODWARD AVENUE, SUITE 2700, DETROIT, MI, 48226-3489, US

(73) Assignee: Johnson Controls Technology Company

(21) Appl. No.: 10/700,878

(22) Filed: Nov. 4, 2003

Related U.S. Application Data
(60) Provisional application No. 60/424,294, filed on Nov. 6, 2002.

(51) Int. Cl. B60N 2/07

(52) U.S. Cl. 296/65.13

(57) ABSTRACT

A cantilever supported vehicle seating system for a vehicle with the vehicle having a floor, the seating system comprising a cantilever base structure coupled to the vehicle and extending longitudinally in the middle of the vehicle. A first pair of occupant seats, with each seat cantilever coupled to the cantilever base structure and with each seat of the first pair of occupant seats including a seat back and a seat base. A second pair of occupant seats, with each seat cantilever coupled to the cantilever base structure and with each seat of the second pair of occupant seats including a seat back and a seat base.

### CROSS-REFERENCE TO RELATED PATENT APPLICATIONS

This application claims benefit of U.S. Provisional Application No. 60/424,294 filed Nov. 6, 2002, which is incorporated herein by this reference.

### BACKGROUND AND FIELD OF THE INVENTION

The present invention relates generally to the field of seats for use in vehicles and more particularly to the field of cantilever supported vehicle seats.

It is known to provide a cantilever supported seat in a vehicle. In particular, many designs and attempts have been made is mass transit applications such as busses and trains which generally benefit from occupants having ready and easy access to space around the seat to more easily stow articles, luggage, packages and the like. For example, many references date back to the early and mid 1900's such U.S. Pat. Nos. 1,206,208; 1,427,280; 1,584,545; 1,649,608; 2,116,366; 3,131,964; 3,317,176; 3,482,875, 4,372,607 the disclosures of which are all incorporated herein by reference. In addition to the above, several fully, cantilever supported bench seat examples are shown in U.S. Pat. Nos. 3,619,006 3,951,454, 4,890,884 which are also incorporated herein by reference. Some of the above examples are more aptly described as pedestal base supported seats. Some may have an offset is the base to give a cantilever effect. For example, U.S. Pat. Nos. 3,632,159; 4,105,245; and 6,106,066 provide examples of offset base supported seats, the disclosures and teaching of which are incorporated herein by reference.

It is also known to provide a cantilever supported vehicle seat utilizing a tube aligned perpendicular to the length of the vehicle and cantilever supporting the vehicle seat at the front of the seat base which would be aligned with an occupant's knees at a position perpendicular to the longitudinal axis of the vehicle. For example, see U.S. Pat. No. 6,394,525, incorporated herein by reference, discloses such a cantilever supported vehicle seat allowing the seat back to fold onto the seat base and then the folded seat tumbles ninety degrees to a stow position. The '525 reference also discloses that the cantilever supported vehicle seat includes a single rear latch member releasably attached to the floor of the vehicle.

In addition to the prior art shown in the above patents, several automotive manufacturers (also known as “OEMs”—original equipment manufacturers), have developed and suggested a variety of cantilever supported seats due to the noted perceived benefits. Such intended benefits typically include better storage and appearance aspects, increased foot room for occupants, easier and improved ingress and egress from the vehicle.

However, many of the existing designs have significant drawbacks. Many cantilever designs result in increased total vehicle weight, additional costs related to complex assemblies, increased total system costs, and including the uncertainty in adopting unproven designs. Accordingly, there remains a significant need to develop better, more comprehensive cantilever supported seat designs which overcome these and other drawbacks associated with the known designs.

In view of the above noted drawbacks with the existing cantilever supported seating systems, there remains a significant need to improve the known systems or to develop a system without the noted drawbacks. A new system is needed which can provide better storage and seating options while not experiencing the aforementioned problems and limitations of the known systems.

### SUMMARY

There is provided a cantilever supported vehicle seating system for a vehicle with the vehicle having a floor. The seating system comprises a cantilever based structure coupled to the vehicle and extending longitudinally in the middle of the vehicle. A first pair of occupant seats, with each seat cantilever coupled to the cantilever base structure and with each seat of the first pair of occupant seats including a seat back and a seat base. A second pair of occupant seats, with each seat cantilever coupled to the cantilever base structure a spaced distance from the first pair of occupant seats and with each seat of the second pair of occupant seats including a seat back and a seat base, with the seat base having a seat bottom. The cantilever base structure can be integrally formed with the vehicle floor.

There is also provided a cantilever base support structure for use in a vehicle, with the vehicle having a floor. The cantilever base support structure comprises a plurality of cantilever support beams extending longitudinally in the vehicle, with each support beam having a first end and a second end. A first end support plate coupled to each first end of each cantilever support beam, and with the first end support plate coupled to the vehicle floor. A second end support plate coupled to each second end of each cantilever support beam and with the second end support plate coupled to the vehicle floor. Another embodiment includes at least one additional support plate coupled to each support beam and located between the first and second end support plates with the additional support plate coupled to the vehicle floor.

There is also provided a method to increase storage and cargo space in a vehicle. The vehicle has a floor. The method comprises the steps of providing a cantilever base structure. Coupling the cantilever base structure to the vehicle with the base structure extending longitudinally in the middle of the vehicle. Providing a first pair of occupant seats. Coupling a cantilever support member having a distal end to each of the first pair of occupant seats. Coupling each one of the first pair of occupant seats to the cantilever base structure, with the first seat of the first pair of occupant seats on one side of the base structure and the second seat of the first pair on the other side of the base structure opposite the first seat of the first pair of seats. Providing a second pair of occupant seats. Coupling a cantilever support member having a distal end to each of the second pair of occupant seats. Coupling each one of the second pair of occupant seats to the cantilever base structure a spaced distance from the first pair of seats, with the first seat of the second pair of occupant seats on one side of the base structure and the second seat of the second pair of occupant seats on the other side of the base structure opposite the first seat of the second pair of seats. Wherein, the distal end of each cantilever support member is not connected to any other structure of the vehicle allowing unobstructed space under each seat. The method may also include the step of configuring at least one of the seats for at least one of a fore, aft, up, down and rotation movement.

These and other features, aspects, and advantages of the cantilever support vehicle seat and system will become more apparent from the following description and accompanying exemplary embodiments shown in the drawings.

### BRIEF DESCRIPTION OF THE DRAWINGS

FIG. 1 is a plan side view of a vehicle including an exemplary embodiment of a cantilever supported seating system, with storage space for items under the seats.

FIG. 2 is perspective view of an exemplary embodiment of a seat cantilever coupled to a cantilever base structure.

FIG. 3 is a perspective view of an exemplary embodiment of a seat cantilever coupled to a cantilever base structure and including a reinforcement member to transfer a side impact force to the cantilever base structure.

FIG. 4 is a partial sectional view of the reinforcement member illustrated in FIG. 3 along the line 4-4.

FIG. 5 is a perspective view of another exemplary embodiment of a seat cantilever coupled to a cantilever base structure and including a shroud member in contact with the reinforcement member and coupled to the cantilever base structure and engaged in a slot defined in the vehicle floor.

FIG. 6 is a perspective view of a vehicle including an exemplary embodiment of a cantilever supported seating system detailing the structure for a first pair of occupant seats and a second pair of occupant seats.

FIG. 7 is a perspective view of an exemplary embodiment of a support structure for a cantilever supported vehicle seat and illustrating cargo space under the seat support structure.

FIG. 8 is a rear perspective view of an exemplary embodiment of a seat cantilever supported to the cantilever base structure having an end support plate and an additional support plate, each coupled to a plurality of support beams.

FIG. 9 is a plan side view of an exemplary embodiment of a rear occupant seat illustrating the seat back folded onto the seat base in a first position.

FIG. 10 is a plan view of the rear occupant seat illustrated in FIG. 9 rotatably moved to a second position, with the bottom of the seat base facing away from the vehicle floor.

FIG. 11 is a perspective view of an exemplary embodiment of an occupant seat illustrated in FIGS. 9 and 10 folded and in a second position with the bottom of the seat base facing away from the vehicle floor and including a plurality of cargo tie-downs.

FIG. 12 is a side view of a vehicle including a cantilever supported seating system illustrating one of a first pair of occupant seats coupled to a cantilever base support structure in an alternate stow position and seating arrangement to accommodate cargo, for example, a baby stroller.

### DETAILED DESCRIPTION OF EXEMPLARY EMBODIMENTS

Several embodiments of the cantilevered supported vehicle seating system are described herein.

One embodiment relates to a vehicle having a cantilever supported vehicle seating system. The seating system includes four occupant seats each being cantilever supported from a cantilever base support or structure integrated into the vehicle and providing highly flexible storage capability. The four occupant seats include a first row of cantilever supported seats and second row of cantilever supported seats. The first row of cantilever supported seats, for a driver and a front passenger, are fully adjustable including fore, aft, up, down and rotation of the seat base and seat back. The second row of cantilever supported seats are adjustable and can be folded and stowed in a variety of combinations allowing the first and second row of seats to achieve a variety of seating and storage configurations.

The cantilever base support structure extends along a center section of the vehicle and has a substantially trapezoid or quadrilateral configuration in cross section and preferably includes four base support or beam members. In one embodiment, the cantilever base support structure includes at least a pair of end plate supports between which the four beam members extend. In an alternate embodiment, additional plate supports are added at given locations along the cantilever base support structure to help transfer loads between the seat and the vehicle. Each plate support preferably has a substantially trapezoid or quadrilateral configuration for carrying and transferring loads and each beam member is connected to or extends through a passage in the plate support. Each beam support is preferably positioned with respect to a respective corner of the plate supports.

In one embodiment, the cantilever base support structure (or tunnel) is a separate system that is separately, substantially assembled and then added to the vehicle by connecting the cantilever base support structure to the floor of the vehicle using any known or appropriate fastener or connection system. In one embodiment, the cantilever base support structure has the seats connected or installed thereto prior to installation of the structure in the vehicle and in an alternate embodiment, the seats are mounted on the cantilever base support structure after the structure is mounted in the vehicle. In a further alternate embodiment of the present invention, the cantilever base support structure is constructed as a unitary part of the vehicle and the seats are connected or installed to the cantilever base support structure as part of the assembly of the vehicle.

In one embodiment, the cantilever base support structure includes a plurality of tracks connected thereto. A pair of tracks of the plurality of tracks support a cantilever supported seat and provide for at least the fore and aft adjustments of the seat. Accordingly, a first track is connected to a first base support member and a second track is connected to a second base support member and the seat is connected to a seat carrier member which is connected to the first and second tracks for relative movement thereon.

In one embodiment, the cantilever supported seat first and second cantilever support members extending from a cantilever base support structure connecting an underside of the seat base with the seat carrier member. The cantilever support members each have a substantially engineered, triangular design extending under the seat base. The first cantilever support member preferably extends under the front of the seat base and the second cantilever support member is preferably spaced apart therefrom and extends under the rear of the seat base.

In one embodiment, the cantilever supported seat is provided with an integrated safety belt having a shoulder belt located to the inner side of the seat toward the cantilever support structure. The integrated safety belt has one end including a retractor anchored to the second cantilever support member and the other end anchored to the cantilever base support structure. The safety belt includes a clip connected to the safety belt for connection with a tether connected to the outer side of the seat base such that the safety belt provide a three point connection for a seat occupant.

In one embodiment, the second cantilever support of the cantilever supported seat of the present invention includes a cantilever cross beam support having a structure appropriate for transferring side impacts to the vehicle to the cantilever base support structure in the center of the vehicle. In one embodiment, the cantilever cross beam support preferably has a solid cross section construction and has at least a portion of the beam extending beyond the outer side of the seat.

In one alternate embodiment, a cantilever supported vehicle seat has a seat frame with a front portion and a rear portion with a seatback pivotally coupled to the rear portion and the front portion of the seat is coupled to, and cantilever supported from, a cantilever support tube which extends in a direction orthogonal to the cantilever base support structure. The cantilever support tube is preferably coupled to one or both of a base support member and a cantilever base end plate support. In this embodiment, the cantilever supported seat is pivotally supported on the cantilever support tube and is capable of rotating on the cantilever support tube through approximately 180 degrees of rotation such that a bottom of the seat base is facing in a direction away from the floor of the vehicle and toward the ceiling of the vehicle. In this position, the underside of the seat base may be used as an elevated stowage tray including tethers for anchoring items thereon.

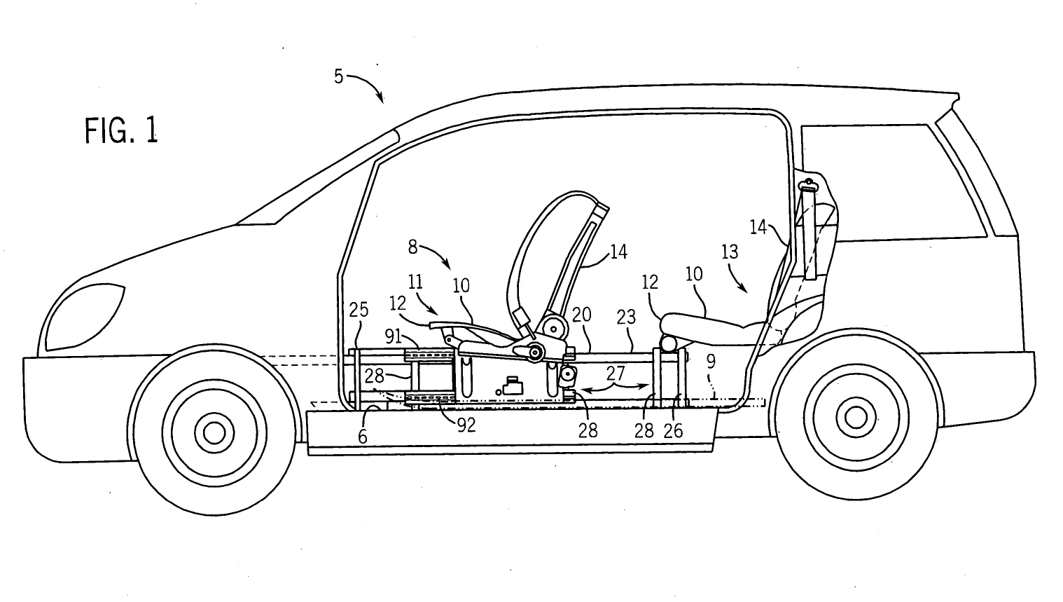

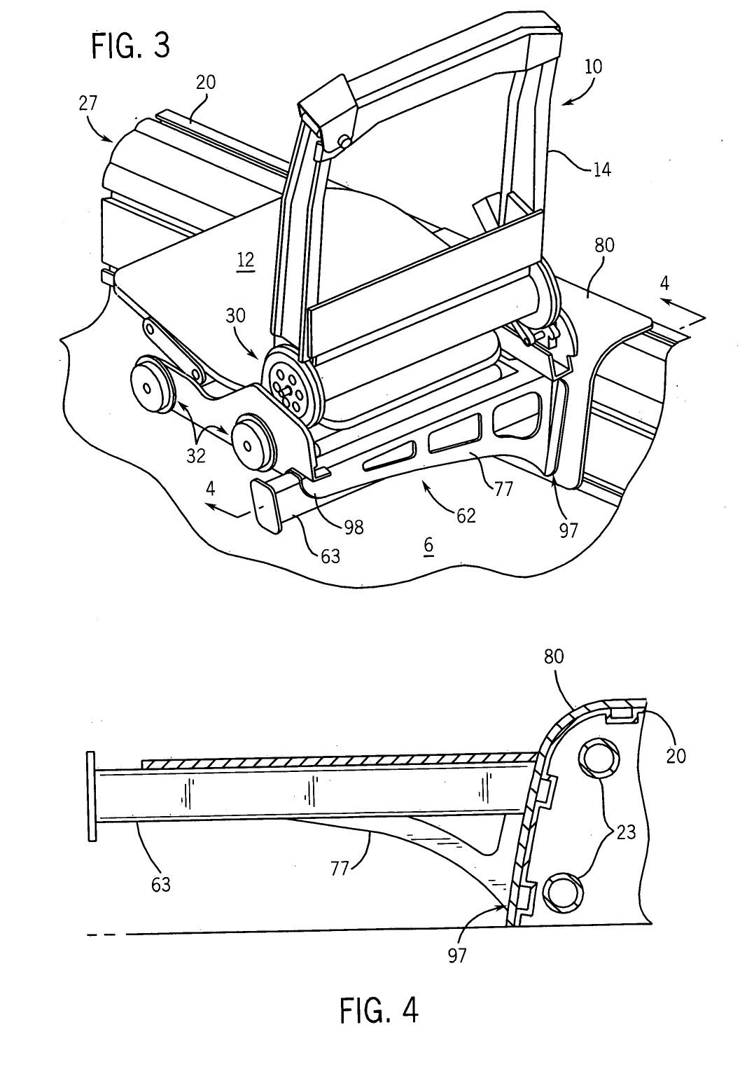

Referring generally to FIGS. 1 through 12 there is shown a vehicle 5 having a floor 6. The floor 6 of the vehicle 5 has any known or appropriate configuration but is preferably substantially flat. The vehicle 5 further includes a cantilever supported vehicle seating system 8 including four cantilever supported vehicle seats. Included in the system 8 is a pair of cantilever supported vehicle seats 10 as part of a first row 11 of seats. Also included in the system 8 is a second row 13 of cantilever supported vehicle seats 10.

The seats 10 each include a seat base 12 and a seat back 14 as having most any known or appropriate general construction and including details particular to the present invention as further described below. The cantilever supported vehicle seating system 8 further includes a cantilever base support structure 20 located substantially in the middle of the vehicle 5 and extending longitudinally therewith. The seats 10 are cantilever supported from the cantilever base support structure 20 to provide nearly complete pass through along the entire floor 6 of the vehicle 5 to provide easier storage and access for an relatively lengthy item such as a pair of skis 9. While the vehicle 5 has a nearly complete pass through along its floor 6, it is still provided with relatively full feature seating for the occupants of the vehicle 5.

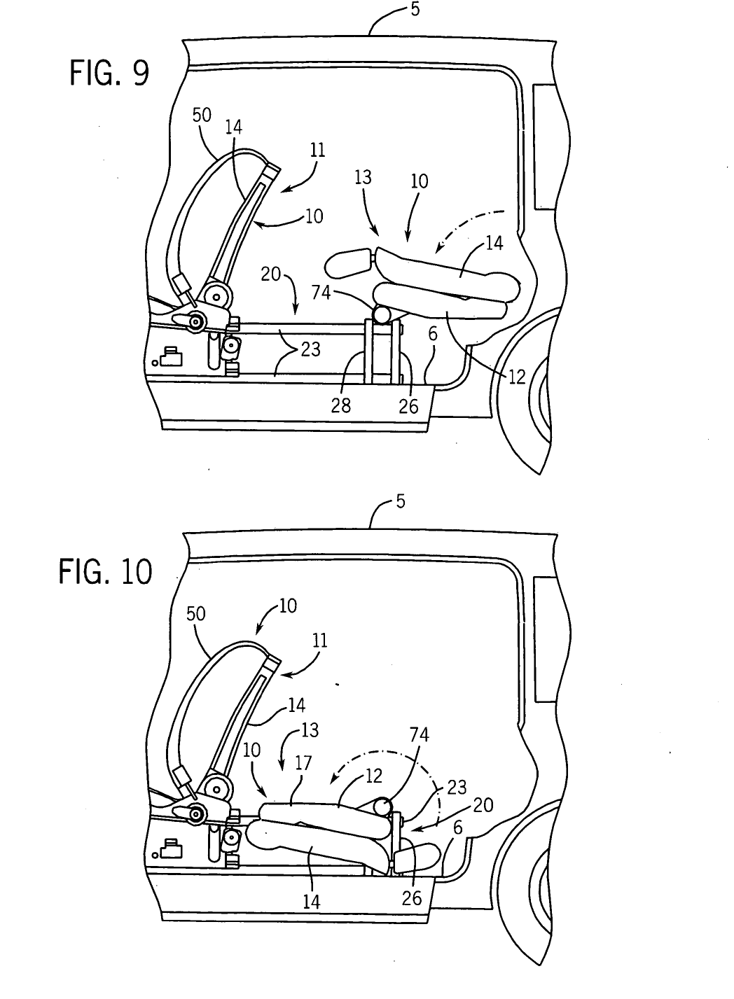

The cantilever supported vehicle seating system 8 is capable of achieving several additional configurations to provide a variety of stowage and seating options providing a variety of occupant features and advantages. Further, as shown in FIGS. 9-11, the second row 13 seats 10 are cantilever supported by the cantilever base support structure 20 such that the seat back 14 can be folded flat with the seat base 12 and then the folded seat 16 can be rotated through approximately a 180 degrees such that a bottom 17 of the seat 16 faces in a direction toward a ceiling of the vehicle 5 and away from the floor 6. Additionally, the bottom 17 of the seat 16 is equipped with straps or tie-downs 18 for retaining cargo or other items to the bottom 17 of the seat 16 (See FIG. 11).

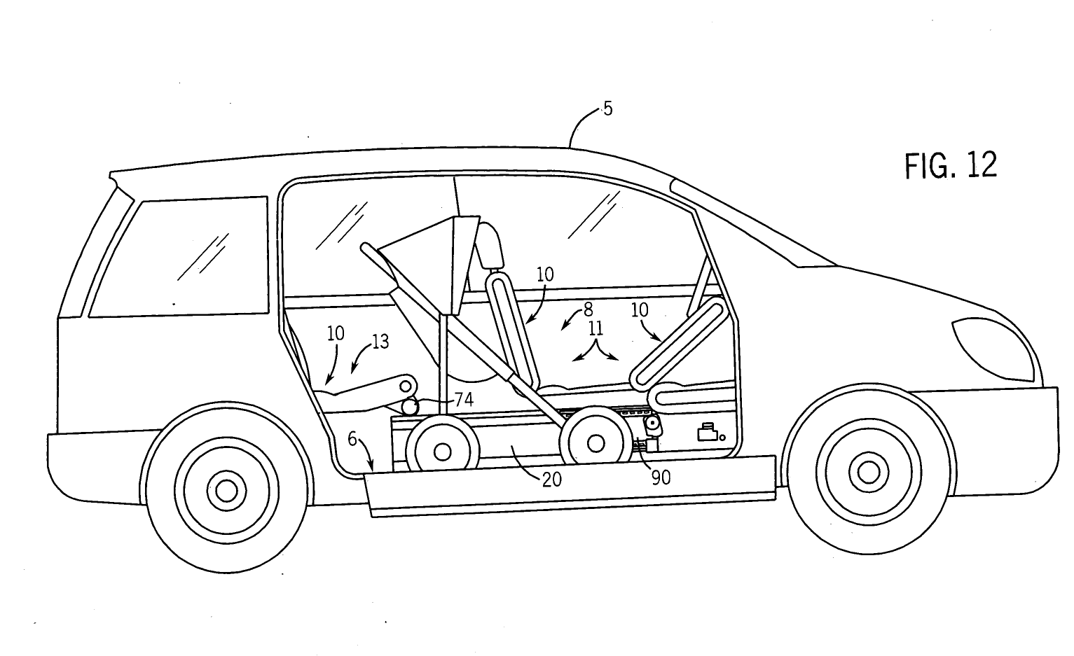

FIG. 12 shows the one seat 10 of the front row 11 pair of occupant seats 10 moved to a forward position and provides access for a stroller to be secured between the seats 10 of the first row 11 and the second row 13. It should be noted that the vehicle 5 is of the type that does not have a B pillar and thus advantageously provides access to the interior of the vehicle 5 in combination with the cantilever supported vehicle seating system 8.

An alternate embodiment of the cantilever supported vehicle seating system 8 can be configured with the passenger seat 10 moved to a forward position providing additional leg room for an occupant of the passenger seat 10 and visual access to view a video screen mounted on the cantilever base support structure 20. A table or similar tray can be mounted on the top of the cantilever base support structure 20 proximate to and accessible from the seats 10 for use by an occupant.

Referring now to FIGS. 1,6 through 8 there is shown in greater detail the cantilever supported vehicle seating system 8 in the vehicle 5 including the seat 10 of the first row 11 and the seat 10 of the second row 13. The cantilever supported vehicle seating system 8 includes the cantilever base support structure 20 which is shown in greater detail as including a plurality of cantilever support beams 23 each having a substantially tubular construction but may have any other known or appropriate cross section. The cantilever support beams 23 extend substantially longitudinally with the vehicle 5 and are supported by support plates 25, 26, 28. Each support plate 25, 26, 28 has a substantially trapezoid configuration but may alternatively have any appropriate shape such as any quadrilateral.

As shown, the cantilever base support structure 20 is preferably a separate unit that can be separately produced and then installed in the vehicle 5. Accordingly, the plurality of cantilever support beams 23 and support plates 25, 26, 28 are assembled into the cantilever base support structure 20 constituting a tunnel 27 extending longitudinally in the middle of the vehicle 5. A bottom portion 29 of each support plate 25, 26, 28 is connected to the floor 6 of the vehicle using any known or appropriate connector or fastener mechanism. The tunnel 27 extends from a first end having an end support plate 25 at a forward part of the vehicle 5 toward the back of the vehicle 5 to an end having a second support plate 26. The additional support plates 28 are located along the tunnel 27 to provide sufficient support to the seats 10 as required to carry the attendant loads.

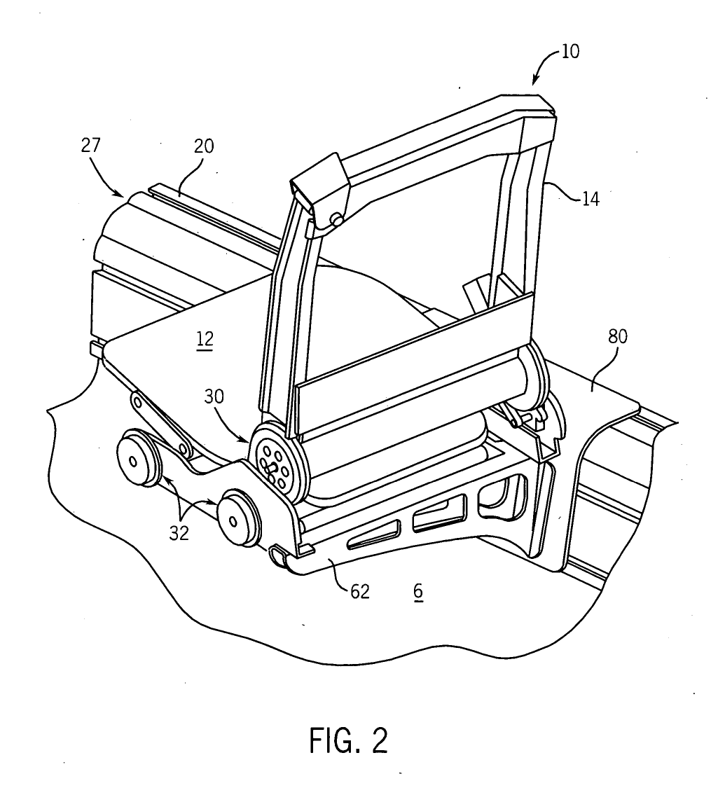

Referring to FIGS. 2 & 3, the seats 10 are more clearly detailed. The seat base 12 of the seat 10 includes a recline mechanism 30 for adjusting the angle of the seat back 14 with respect to the seat base 12. The seat base 12 of the seat 10 further preferably includes a seat base adjustment mechanism 32 for adjusting the heights of the front and rear portions of the seat base 12 with respect to the tunnel 27 and the floor 6.

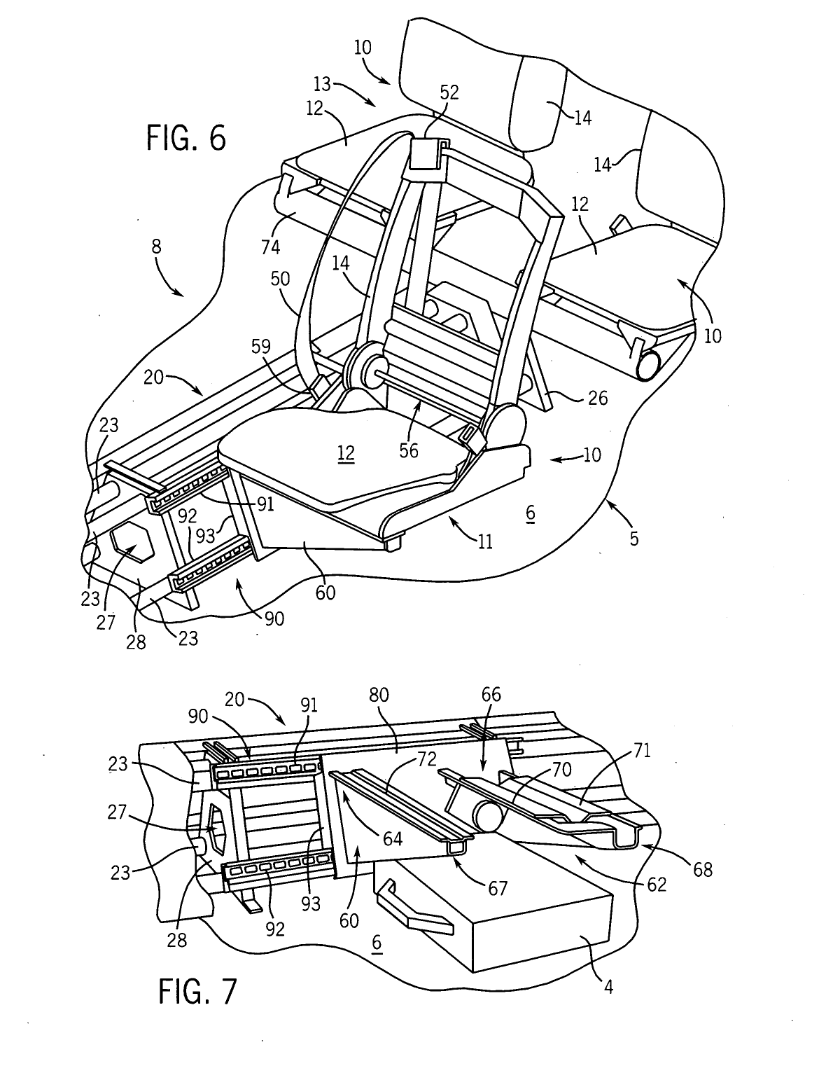

Referring also to FIG. 6 now, the seat 10 is also provided with a belt 50 having a shoulder connection point 52 located on the upper and inner portion of the seat back 14. The seat 10 is connected to a first and second cantilever support members 60 and 62, respectively. The first and second cantilever support members each have a first end 64 and 66, respectively, connected to a carrier member 80 movably attached to the tunnel 27. The first and second cantilever support members 60 and 62 each have a second end 67 and 68, respectively, distal from their first ends 64 and 66 such that the second ends 67 and 68 are not connected to any other structure of the vehicle 5 including the floor 6. The first and second cantilever support members 60 and 62 each have a substantially triangular shape wherein the hypotenuse of the triangle extends from a lower point of the first ends 64 and 66 diagonally upward (away from the floor 6) to the second ends 67 and 68. The distal ends 67, 68 of each of the first and second cantilever support members 60, 62 are not connected to any other structure of the vehicle 5 (See FIGS. 6 & 7).

The first cantilever support member 60 includes a top portion 72 for connection with the seat base 12. The second cantilever support member 62 includes first and second flange members 70 and 71 for providing additional support to the seat base 12 of the seat 10. The first and second cantilever support members 60 and 62 are each connected to the carrier member 80 using any known or appropriate connection or fastener (including welding) but are preferably fixedly connected using bolts however, welding or other suitable adhesive may also be used.

The carrier member 80 is preferably a stamped metal plate having a substantially planar construction and engineered to optimally transfer loads between the first and second cantilever support members 60 and 62 and the cantilever support beams 23 of the tunnel 27. The carrier member 80 may also be composed of one of a composite material and an engineered plastic of suitable strength. While not shown, it is possible to have the carrier member 80 simply fixedly connected to one of or both of the cantilever support beams 23 and the plate supports 25 of the tunnel 27. Preferably, the carrier member 80 is movably connected to the tunnel assembly 27 on a track assembly 90.

The track assembly 90 preferably includes a first upper track member 91 having a first portion connected to support plate 28 and a second portion connected to another support plate 28 and extending substantially along an upper cantilever support beam 23. The track assembly 90 also preferably includes a lower track member 92 having a first portion connected the support plate 28 and a second portion connected to the other support plate 28 and extending substantially along a lower cantilever support beam 23. The track assembly 90 includes a track slide 93 interconnecting the carrier member 80 and the first and second track members 91 and 92, respectively, to provide relative movement there between in manner similar to tracks used on floor supported vehicle seats. The carrier member 80 accordingly adjusts the fore and aft positions of the vehicle seat 10. The carrier member 80 may be operated manually or automatically using an appropriate electric motor driven mechanism.

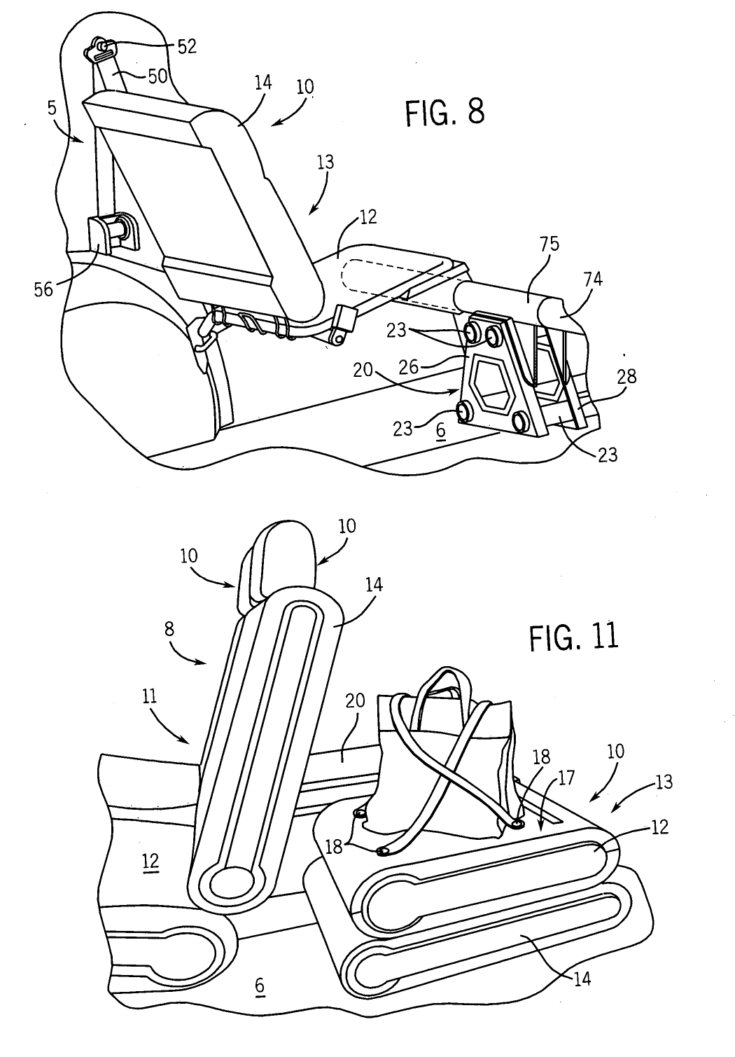

As shown in FIGS. 6 and 8 the belt 50 has a first end connected to the second cantilever support member 62 and includes a retractor/tensioner 56 of an appropriate design for lengthening and tensioning the belt 50 when applied to an occupant. The belt 50 has a second end connected to the carrier member 80 via an anchorage 59 but may alternatively be connected to the inner side of the seat base 12.

FIGS. 6 and 7 further detail the relationship of the cantilever support members 60 and 62 and their connection with the cantilever base structure 20 as well as the ability of the added storage provided by the present design to more easily and readily accommodate the storage of items such as a briefcase 4. The briefcase 4 is positioned between the cantilever support members 60 and 62 and can be accessed from the front, outer side and rear of the seat 10.

FIG. 8 discloses further detail for the seat 10 and its connection to the cantilever base support structure 20. The seat 10 is connected to a cross beam member 74 which is connected to the cantilever base support structure 20. The cross beam member 74 is preferably connected orthogonal to a pair of support plates 26, 28 using a U-shaped bracket 75. The beam 74 is supported by the upper cantilever support beam members 23. The seat 10 and its connection to the beam 74 preferably have a construction and design similar to that shown in U.S. Pat. No. 6,394,525, with one significant difference. The seat 10 is connected to the beam 74 for rotation between the position shown in FIG. 11 and the position shown in FIGS. 9 and 10 and thus is capable of rotating through approximately 180 degrees of rotation.

FIGS. 1 & 12 show a side plan view of the vehicle 5 of the present invention further showing the relationship of the seats 10 with respect to the cantilever base support structure 20 wherein the seat 10 is the full aft position. Further, it should be noted that in the present embodiment there is ample leg room for an occupant in the seat 10 as well as ample storage space along the floor 6 of the vehicle 5.

A series of alternative seating arrangements and storage positions for the first row 11 of seats 10 and the second row 13 of seats 10 connected to the cantilever base support structure 20 and the cross beam 74 according to the present invention. All seats 10 can be in their normal upright position. The cantilever supported vehicle seat system 8 can be configured with a seat 10 is in the forward position to provide additional storage between passenger seats 10 in the first and second pair 11, 13 of seats. The system 8 can be configured so one passenger seat 10 has its seat back 14 folded down and another passenger seat 10 has its seat back 14 folded down and the seat 10 is rotated 160 degrees on the beam 74 to provide additional storage behind the front passenger seat 10 as well as over the other passenger seats 10. The seat back 14 of passenger seat 10 can also be folded down to provide additional storage there above.

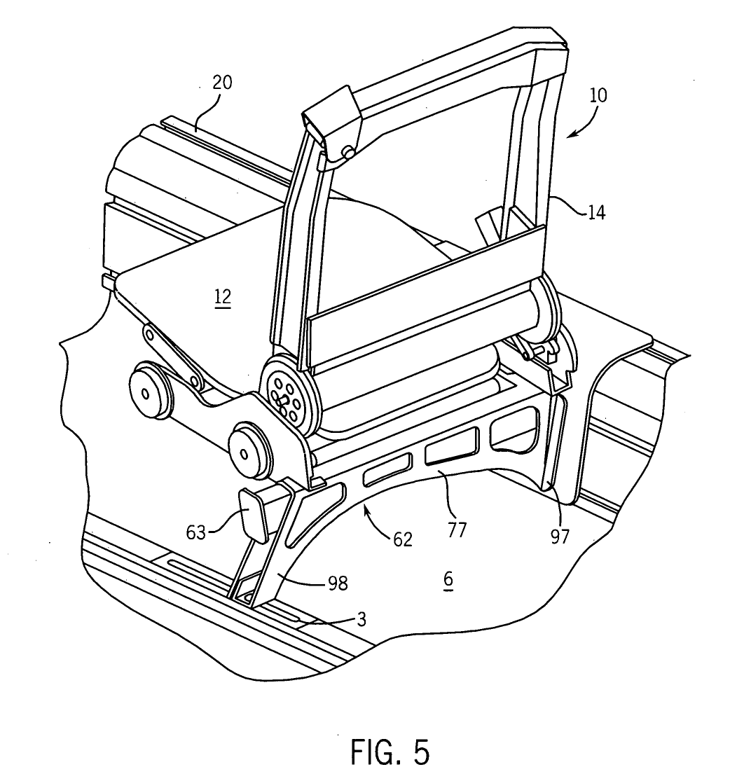

FIG. 5 discloses a vehicle seat 10 wherein the second cantilever support member 62 includes a cantilever support beam reinforcement member 63 extending from the cantilever support structure 20. The reinforcement member 63 is structurally designed to transfer side impacts to the vehicle 5 to the cantilever support structure 20 to protect and occupant of the seat 10. As such, the reinforcement member 63 is preferably a solid structural member capable of withstanding significant force without buckling. In view of the relatively rigid nature of the reinforcement member 63, the cantilever support member 62 further includes a shroud member 77 having a substantially U-shaped design and contacting, for example by surrounding the reinforcement member 63. The shroud member 77 may have a first end 97 connected to the cantilever support structure 20 and a second end 98 having a portion connected to a slot 3 in the floor 6. The shroud member 77 maintains alignment of the reinforcement member 63 particularly during an side impact to the vehicle 5. The reinforcement member 63 may also be configured as a hollow or telescoping tube and may be provided with a shock absorbing member, for example a spring or a hydraulic or pneumatic cylinder.

FIGS. 3 & 4 disclose an alternate embodiment of the vehicle seat 10 of FIG. 21 wherein again the second cantilever support member 62 includes a cantilever support beam reinforcement member 63 extending from the cantilever support structure 20. However, the shroud member 77, while still having a substantially U-shaped design and surrounding the reinforcement member 63 only has a first end 97 connected to the cantilever support structure 20 and the second end 98 is removed. The shroud member 77 still helps to maintain alignment of the reinforcement member 63 during an side impact to the vehicle 5 but now has better accessibility under the seat 10 for storage.

1. A cantilever supported vehicle seating system for a vehicle with the vehicle having a floor, the seating system comprising:
a cantilever base structure coupled to the vehicle and extending longitudinally in the middle of the vehicle;
a first pair of occupant seats, with each seat cantilever coupled to the cantilever base structure and with each seat of the first pair of occupant seats including a seat back and a seat base; and
a second pair of occupant seats, with each seat cantilever coupled to the cantilever base structure a spaced distance from the first pair of occupant seats and with each seat of the second pair of occupant seats including a seat back and a seat base, with the seat base having a seat bottom.

2. The cantilever supported vehicle seating system of claim 1, wherein the cantilever base structure is integrally formed with the vehicle floor.

3. The cantilever supported vehicle seating system of claim 1, wherein the seat back of each seat is configured to fold down over the seat base to form a folded seat.

4. The cantilever supported vehicle seating system of claim 3, including a cross beam member connected to the cantilever base structure and configured to support the second pair of occupant seats.

5. The cantilever support vehicle seating system of claim 3, including a recline mechanism coupled to the seat back and seat base to move the seat back with respect to the seat base.

6. The cantilever supported vehicle seating system of claim 4, wherein the folded seats of the second pair of occupant seats is rotatably movable from a first position to a second position, wherein the seat bottom faces away from the vehicle floor.

7. The cantilever supported vehicle seating system of claim 6, wherein the seat bottom includes a plurality of cargo tie-downs.

8. The cantilever supported vehicle seating system of claim 1, wherein each seat of the first pair of occupant seats is configured for at least one of a fore, aft, up, down, and rotation movement of one of the seat base and seat back.

9. The cantilever supported vehicle seating system of claim 8, including a seat adjustment mechanism for adjustment movements of the seat.

10. The cantilever supported vehicle seating system of claim 1, including a reinforcement member coupled to the cantilever base structure and positioned under the seat base of each one of the first and second pair of occupant seats.

11. The cantilever supported vehicle seating system of claim 10, including a shroud member configured to contact the reinforcement member, with the shroud member coupled to the cantilever base structure.

12. The cantilever supported vehicle seating system of claim 11, wherein the shroud member is also engaged in a slot defined in the vehicle floor.

13. The cantilever supported vehicle seating system of claim 1, including a seat support structure comprising:
a carrier member configured to movably attach to the cantilever base structure; and
a first cantilever support member having a distal end and coupled to the carrier member and to the seat base of each of the first pair of occupant seats.

14. The cantilever supported vehicle seating system of claim 13, including a second cantilever support member having a distal end and coupled to the carrier member and to the seat base of each of the first pair of occupant seats.

15. The cantilever supported vehicle seating system of claim 14, wherein the distal ends of each of the first and second cantilever support members are not connected to any other structure of the vehicle.

16. The cantilever supported vehicle seating system of claim 15, wherein the first and second cantilever support members are configured in a triangular shape.

17. The cantilever supported vehicle seating system of claim 13, wherein the cantilever base structure includes a track assembly configured to engage the carrier member.

18. The cantilever supported vehicle seating system of claim 17, including an electric motor drive mechanism coupled to the carrier member to move the carrier member along the track assembly.

19. The cantilever supported vehicle seating system of claim 13, including an integrated seat belt having a shoulder belt.

20. The cantilever supported vehicle seating system of claim 19, wherein the seat belt has one end including a retractor coupled to the cantilever support member and another end coupled to the cantilever base structure.

21. A cantilever base support structure for use in a vehicle, with the vehicle having a floor, the cantilever base support structure comprising:
a plurality of cantilever support beams extending longitudinally in the vehicle, with each support beam having a first end and a second end;
a first end support plate coupled to each first end of each cantilever support beam, and with the first end support plate coupled to the vehicle floor; and
a second end support plate coupled to each second end of each cantilever support beam, and with the second end support plate coupled to the vehicle floor.

22. The cantilever base support structure of claim 21, including at least one additional support plate coupled to each support beam and located between the first and second end support plates, with the additional support plate coupled to the vehicle floor.

23. The cantilever base support structure of claim 22, wherein each end plate and additional support plate is formed in a trapezoidal configuration.

24. The cantilever base support structure of claim 21, including a first pair of occupant seats, with each seat cantilever coupled to the cantilever base structure and with each seat of the first pair of occupant seats including a seat back and a seat base; and
a second pair of occupant seats, with each seat cantilever coupled to the cantilever base structure a spaced distance from the first pair of occupant seats and with each seat of the second pair of occupant seats including a seat back and a seat base, with the seat base having a seat bottom.

25. The cantilever base support structure of claim 24, wherein the seat back of each seat is configured to fold down over the seat base to form a folded seat.

26. The cantilever base support structure of claim 25, including a cross beam member connected to the cantilever base structure and configured to support the second pair of occupant seats.

27. The cantilever base support structure of claim 25, including a recline mechanism coupled to the seat back and seat base to move the seat back with respect to the seat base.

28. The cantilever base support structure of claim 26, wherein the folded seats of the second pair of occupant seats is rotatably movable from a first position to a second position, wherein the seat bottom faces away from the vehicle floor.

29. The cantilever base support structure of claim 28, wherein the seat bottom includes a plurality of cargo tie-downs.

30. The cantilever base support structure of claim 24, wherein each seat of the first pair of occupant seats is configured for at least one of a fore, aft, up, down, and rotation movement of one of the seat base and seat back.

31. The cantilever base support structure of claim 30, including a seat adjustment mechanism for adjustment movements of the seat.

32. The cantilever base support structure of claim 24, including a reinforcement member coupled to the cantilever base structure and positioned under the seat base of each one of the first and second pair of occupant seats.

33. The cantilever base support structure of claim of claim 32, including a shroud member configured to contact the reinforcement member, with the shroud member coupled to the cantilever base structure.

34. The cantilever base support structure of claim of claim 33, wherein the shroud member is also engaged in a slot defined in the vehicle floor.

35. The cantilever base support structure of claim 24, including a seat support structure comprising:
a carrier member configured to movably attach to the cantilever base structure; and
a first cantilever support member having a distal end and coupled to the carrier member and to the seat base of each of the first pair of occupant seats.

36. The cantilever base support structure of claim 35, including a second cantilever support member having a distal end and coupled to the carrier member and to the seat base of each of the first pair of occupant seats.

37. The cantilever base support structure of claim 36, wherein the distal ends of each of the first and second cantilever support members are not connected to any other structure of the vehicle.

38. The cantilever base support structure of claim 37, wherein the first and second cantilever support members are configured in a triangular shape.

39. The cantilever base support structure of claim 35, wherein the cantilever base structure includes a track assembly configured to engage the carrier member.

40. The cantilever base support structure of claim 39, including an electric motor drive mechanism coupled to the carrier member to move the carrier member along the track assembly.

41. The cantilever base support structure of claim 35, including an integrated seat belt having a shoulder belt.

42. The cantilever base support structure of claim of claim 41, wherein the seat belt has one end including a retractor coupled to the cantilever support member and another end coupled to the cantilever base support structure.

43. A method to increase storage and cargo space in a vehicle, with the vehicle having a floor, the method comprising the steps of:
providing a cantilever base structure;
coupling the cantilever base structure to the vehicle, with the base structure extending longitudinally in the middle of the vehicle;
providing a first pair of occupant seats;
coupling a cantilever support member having a distal end to each of the first pair of occupant seats;
coupling each one of the first pair of occupant seats to the cantilever base structure, with the first seat of the first pair on one side of the base structure and the second seat of the first pair on the other side of the base structure opposite the first seat of the first pair;
providing, a second pair of occupant seats;
coupling a cantilever support member having a distal end to each of the second pair of occupant seats; and
coupling each one of the second pair of occupant seats to the cantilever base structure a spaced distance from the first pair of seats, with the first seat of the second pair on one side of the base structure and the second seat of the second pair on the other side of the base structure opposite the first seat of the second pair,
wherein the distal end of each cantilever support member is not connected to any other structure of the vehicle allowing unobstructed space under each seat.

44. The method of claim 43, including the step of configuring at least one of the seats for at least one of a fore, aft, up, down, and rotation movement.
